(19) United States
(12) Patent Application Publication
(10) Pub. No.: US 2004/0000232 A1
(43) Pub. Date: Jan. 1, 2004

(54) Device and method for exchanging oxygen and carbon dioxide between a gas and an aqueous liquid

(76) Inventors: William J. Van Horne, Boulder, CO (US); Kerry Kring, Boulder, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/292,834

(22) Filed: Nov. 12, 2002

Related U.S. Application Data
(60) Provisional application No. 60/338,198, filed on Nov. 13, 2001.

(51) Int. Cl. B01D 19/00

(52) U.S. Cl. 95/46; 96/6

(57) ABSTRACT

An apparatus for exchanging oxygen and carbon dioxide between a gas and an aqueous liquid, usually fresh water or sea water, using a plurality of hollow fiber gas permeable membranes. Oxygen is extracted from a surrounding liquid into the fibers and carbon dioxide is diffused from the fibers into the surrounding liquid. The oxygen rich gas within the membranes is distributed through a breathing device to a user.

### PRIORITY

This application claims priority to U.S. Provisional Application No. 60/338,198 filed on Nov. 13, 2001, the details of which are incorporated by reference into the present application.

### FIELD OF THE INVENTION

The invention is directed toward a device for extracting dissolved gases from a liquid, preferably either sea water or fresh water. More particularly, the invention is directed toward a device for use in extracting dissolved oxygen from water in a SCUBA environment.

### BACKGROUND OF THE INVENTION

Gas permeable hollow fiber membranes, notably hollow fibers of micro-porous polypropylene, have been used in the medical industry to both oxygenate blood and remove carbon dioxide from blood. U.S. Pat. No. 4,770,852 to Takahara et al., the details of which are hereby incorporated by reference into the present application, describes the use of hollow fiber membranes in the medical field. Some of the notable benefits of hollow fiber membranes include modest energy requirements, a lack of waste products, large surface area per unit volume, flexibility, and a low operating cost. Hollow fiber membranes are particularly useful in gas separation processes because of their high separation areas and selectivity.

The excellent mass-transfer properties conferred by the hollow fiber configuration has led to numerous commercial applications in various fields such as the medical field (blood fractionation), water reclamation (purification and desalination), gas separation, and azeotropic mixture separation (using pervaporation). Other applications of this type of membrane are in various stage of development, e.g. and the biochemical industry (bioseparation and bioreactor) and hydrocarbon separation (by pervaporation).

The two basic morphologies of hollow fiber membranes are isotropic and anisotropic, the basic properties of which are illustrated in FIG. 1. Membrane separation is achieved by using one of these morphologies. Various types of membrane configurations are detailed in FIG. 2.

Hollow fiber is one of the most popular membranes used in industries. It is because of its several beneficial features that make it attractive for those industries. Among those benefits are:

Modest energy requirements—In a hollow fiber filtration process, no phase change is involved. Consequently, no latent heat is needed. This gives the hollow fiber membrane the potential to replace the unit operations which consume heat, such as distillation or evaporation columns.

No waste products—Since the basic principal of a hollow fiber is filtration, it does not create any waste from its operation except the unwanted component in the feed stream. This can help to decrease the cost of operation to handle the waste.

Large surface per unit volume—Hollow fiber has a large membrane surface per module volume. Hence, the size of hollow fiber is smaller than other types of membrane but can give higher performance.

Flexibility—Hollow fiber is a flexible membrane, thus it can carry out the filtration by 2 ways, either “inside-out” or “outside-in.”

Low operation cost—Hollow fiber has a low operation cost compared to other types of unit operations.

Some of the more notable membrane processes include reverse osmosis (RO), pervaporation (PV), and gas separation.

Gas membranes are now widely used in a variety of application areas. Table 2, reproduced from “Economics of Gas Separation Membranes” R. W. Spillman, Chemical Engineering Progress, Vol. 85, No. 1, pp. 41-62 (1989), show some of these applications, the details of which are incorporated by reference into the present application. Their wide use is because of the advantages in separation, low capital cost, low energy consumption, ease of operation, cost effectiveness (even at low gas volumes), and good weight and space efficiency.

TABLE 2
Gas Membrane Application Areas

| Common Gas Separation | Application |
|---|---|
| O₂/N₂ | Oxygen enrichment, inert gas generation. |
| H₂/Hydrocarbons | Refinery hydrogen recovery |
| H₂/N₂ | Ammmonia Purge gas |
| H₂/CO | Syngas ratio adjustment |
| CO₂ /Hydrocarbons | Acid gas treatment, landfill gas upgrading |
| H₂O/Hydrocarbons | Natural gas dehydration |
| H₂S/Hydrocarbons | Sour gas treating |
| He/Hydrocarbons | Helium separation |
| He/N₂ | Helium recovery |
| Hydrocarbons/Air | Hydrocarbons recovery, pollition control |
| H₂O/Air | Air dehumidification |

From “Economics of Gas Separation Membrane” R. W. Spillman, Chemical Engineering Progress, Vol. 85, No. 1, pp. 41-62 (1989). Reproduced by permission of the American Institute of Chemical Engineers \mathring{c}1989 AICHE.

Furthermore, hollow fiber is playing an important role in gas separation because of its high separation areas and selectivity. The hollow fibers have approximately 30 times the productivity of other oxygen enriching membranes plus excellent inertness associated with their totally fluorinated chemistry. The market of the gas separation include, small and intermediate scale industrial oxygen and nitrogen at moderate purity levels (oxygen 25%-40% or nitrogen 82%-95%), portable oxygen for respiratory care, enhanced engine power and emissions reduction.

The low capital cost of hollow fiber has also lead to its popularity. For example, for oxoalcohol feed separation, the process cost is about 1.000 for hollow fiber membrane. However, for cryogenic (partial condensation) and PSA processes are about 1.234 and 1.133 respectively. Thus, most of the cost for hollow fiber is for compression and not for purification. This is partly because hollow fiber itself already provides a good medium for purification.

What is needed is a device that can utilize the features of gas permeable hollow fiber membranes in order to provide a device that can extract oxygen from a surrounding water environment and provide that oxygen to a user, preferably in the form of an under water breathing device.

### SUMMARY OF THE INVENTION

Using a closed breathing loop, a diving gas mixture, either air or a helium based gas is drawn through hollow fiber membranes. The hollow fiber membranes are surrounded by circulating water. When the circulating water passes the hollow fiber membranes, oxygen is extracted from, and carbon dioxide is dissolved into, the water. An associated tank of a compressed diving gas mixture may be attached through a pressure regulator to automatically maintain a constant pressure within the closed breathing loop as well as to provide life support in the event of system failure. An air pump may optionally be connected to provide for a higher pressure differential across the hollow fiber membranes.

In one aspect, a device for extracting dissolved oxygen from a liquid, comprises a gas exchange module having a plurality of hollow fiber membranes. The hollow fiber membranes have a generally cylindrical outer wall, a first end, a second end, and an internal lumen extending from the first end to the second end, wherein the hollow fiber membrane is adapted to allow oxygen to pass through the outer wall and into the lumen.

In another aspect, a device for extracting dissolved oxygen from a liquid, comprises a hollow fiber membrane having a generally cylindrical outer wall, the hollow fiber membrane having a first end, a second end, and an internal lumen, wherein the hollow fiber membrane allows dissolved oxygen to pass through the wall and into the lumen, an input fitting coupled to the first end of the hollow fiber membrane, an output fitting coupled to the second end of the hollow fiber membrane, and a passageway for directing the liquid across the surface of the hollow fiber membrane and thereby allowing oxygen to be extracted into the lumen of the hollow fiber membrane.

In a further embodiment, a gas exchange device, comprises a housing having an internal chamber, the chamber having an inlet port and an outlet port for circulating a liquid containing dissolved oxygen throughout the internal chamber, the chamber further comprising a gas inlet and a gas outlet, a plurality of hollow fiber membranes each having a first end, a second end, and an internal lumen extending from the first end to the second end, wherein each of the first ends are coupled to the gas inlet and each of the second ends are coupled to the gas outlet, wherein the plurality of hollow fiber membranes extract the dissolved oxygen within the liquid into the lumens when the liquid passes across the plurality of hollow fiber membranes.

In yet another aspect, a method of extracting dissolved oxygen from a liquid comprises providing a plurality of hollow fiber membranes having an internal lumen, and an outer wall with a pore size adapted to allow dissolved oxygen contained in the liquid to pass through the outer wall, passing the liquid across the plurality of hollow fiber membranes, and extracting a portion of the dissolved oxygen from the liquid.

As will be come apparent to those skilled in the art, numerous other embodiments and aspects will become evident hereinafter from the following descriptions and claims.

### BRIEF DESCRIPTION OF THE DRAWINGS

The drawings illustrate both the design and utility of the preferred embodiments of the present invention, in which similar elements in different embodiments are referred to by the same reference numbers for purposes of ease in illustration of the invention, wherein:

FIG. 1 is a diagram illustrating several of the different membrane morphologies associated with hollow fiber membranes;

FIG. 2 is a diagram illustrating the various module configurations for use with hollow fiber membranes;

FIG. 3 is a diagram of a preferred embodiment of a breathing device constructed in accordance with the present invention;

FIG. 4 is a detailed view of a hollow fiber membrane utilized in a breathing device constructed in accordance with the present invention;

FIG. 5 is a cross-sectional view of a hollow fiber membrane utilized in a breathing device constructed in accordance with the present invention; and

FIG. 6 is a diagram of an alternate arrangement of the hollow fiber membranes within a breathing device constructed in accordance with the present invention.

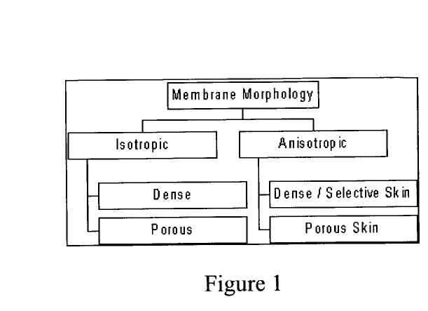

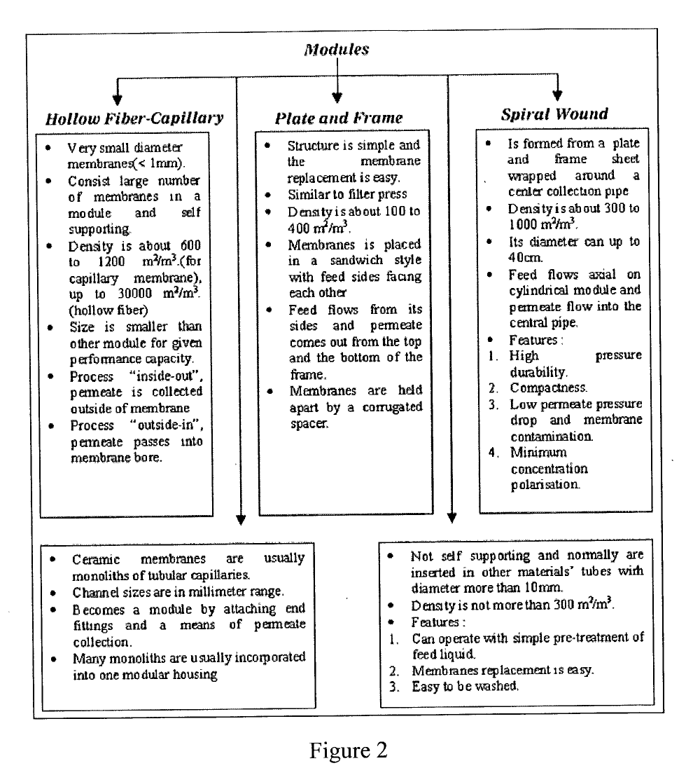

### DETAILED DESCRIPTION

FIG. 3 shows a preferred embodiment of an under water breathing device 10 constructed in accordance with an aspect of the present invention. The breathing device 10 includes a main module 15 that has a gas input fitting 20 and a gas output fitting 25. In one embodiment, the main module is in the form of a small wearable tank. A pump 30 is preferably coupled to a water inlet 35 and forces water into a chamber 40 of the main module 15. The chamber 40 houses a gas exchange module 45. The gas exchange module 45 is preferably formed from a bundle of hollow fiber membranes adapted to extract a dissolved gas from a liquid. More than one bundle of hollow fibers may be used in the gas exchange module 45. Additionally, any number of individual hollow fibers may be used within each of the bundles and may vary depending on the application. Various commercially available hollow fiber membranes may be incorporated into the gas exchange module 45. For example, the hollow fiber membranes described below represent several embodiments of such hollow fiber membranes. In addition, hollow fiber membranes manufactured by the Minntech corporation represent other examples of such membranes.

In accordance with an aspect of the present invention, hollow polypropylene fibers with generally cylindrical walls and micro-porous membranes and which may have a nominal wall thickness of approximately 50 microns and an outside diameter of 280 microns are bundled together in parallel, and then bound together at their two ends with an appropriate non-toxic waterproof sealant. The fibers are bound in such a way and with such a sealant as to keep the fiber ends open. Each end of this fiber bundle is then inserted into a piece of flexible plastic tubing such as extruded polyvinyl chloride, and then sealed with the waterproof sealant, again making sure the ends of the fibers are not closed by the sealant. The finished gas exchange module 45 thus resembles a horse's tail, with both ends of the tail stuck into plastic tubing. Various other configurations of the gas exchange module 45 may be employed. The bundle may be coiled or stretched relatively straight, depending on the application.

The gas exchange module 45 is mounted inside of the main module 15 preferably using quick release connectors 47 and 49 which allow for its easy removal and replacement. In addition to the water inlet 35, the main module has a water outlet 50, which in combination with the inlet 35, allows water to continuously circulate through the tank. The pump 30 may be used to maintain a consistent water flow through the main module chamber 40. Alternately, the movement of the breathing device 10 through the water helps maintain continuous circulation.

A gas exit tube 55 is coupled to the output fitting 25. In one embodiment, a pressurized gas container 65 is coupled to the gas exit tube 55 via a pressure regulator 70, distribution tube 75 and fitting 60. The gas container 65 may be used to maintain an efficient gas diffusion across the hollow fiber membranes, as well as a comfortable breathing pressure for a user. An oxygen and/or carbon dioxide sensor 83 is mounted in the closed breathing loop (represented by arrows) preferably downstream of the fitting 60. The sensor 83 provides feedback to a microprocessor 87, which determines if the gas mixture in the breathing loop needs to be adjusted. The microprocessor 87 controls the pressure regulator 70 to allow additional oxygen into the breathing loop as necessary from the gas container 65.

The fitting 60 is coupled to a regulator 85 via another distribution tube 80. Regulator 85 is used to deliver breathable gas to a user, such as with the second stage of a standard SCUBA system regulator. Gas exhaled by a user through the regulator 85 is directed through an output distribution tube 90, through an air pump 95, and back into the main module 15 through another distribution tube 100. The distribution tube 100 is coupled to the input fitting 20. The exhaled gas is then re-oxygenated in the gas exchange module 45, via the hollow fiber membranes, and again distributed to the user for breathing. The air pump 95 is optional and is intended to augment the pressure differential through the gas exchange module 45. The air pump 95 can be installed on either end of the gas exchange module 45 and functions to either push or pull the gas through the fibers.

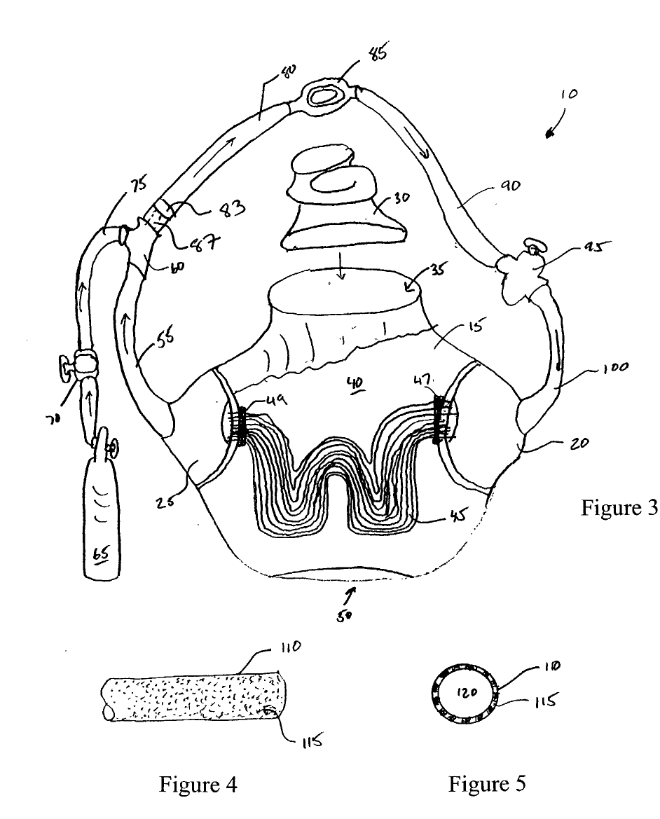

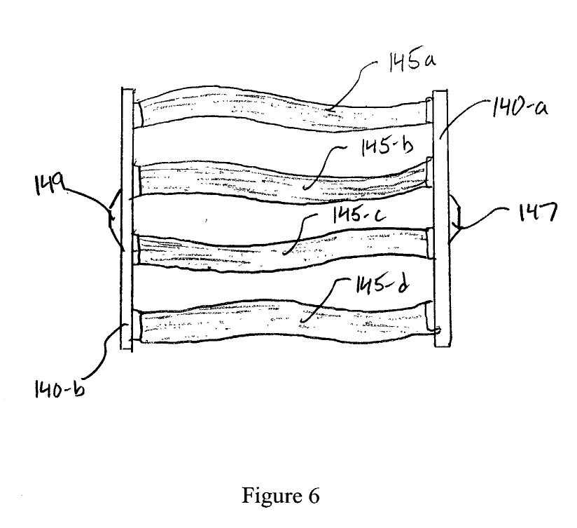

FIGS. 4 and 5 show details of one embodiment of the individual hollow fiber membranes 110 used within the gas exchange module 45. In one embodiment, the hollow fiber membranes 110 are comprised of a tubular passage that includes a central lumen 120 and a plurality of apertures 115 through the walls of the membranes 110. The hollow fiber membrane 110 is porous to gases but not to liquids, thus the membrane can extract oxygen (or another gas) from an oxygen-rich liquid flowing past the membrane 110. In addition, the hollow fiber membranes are preferably formatted to allow oxygen to pass from the surrounding water into the lumens of the fibers while also allowing carbon dioxide to pass from the fiber lumens back into the surrounding water. Various embodiments of the hollow fiber membranes 110 are contemplated by the present invention, including the use of various materials and wall thicknesses and the descriptions provided herein are not intended to be limiting in any way. For example, various configurations of the hollow fiber membranes within the gas exchange module 45 are contemplated, including various membrane diameters and lengths, as well as the use of various numbers of membranes within the bundle of membranes. In addition, a manifold of several bundles of hollow fiber membranes may be utilized to increase the surface contact area between the fibers and the surrounding water. FIG. 6 illustrates such an embodiment where hollow fiber membrane bundles 145a-d are connected to an inlet manifold 140-a and an outlet manifold 140-b. Connectors 147 and 149 allow for connection to a gas distribution system as previously described in conjunction with FIG. 3. Depending on the application and other variables of usage, the configuration of the gas exchange module may be varied accordingly.

Although the present invention has been described and illustrated in the above description and drawings, it is understood that this description is by example only and that numerous changes and modifications can be made by those skilled in the art without departing from the true spirit and scope of the invention. The invention, therefore, is not to be restricted, except by the following claims and their equivalents.

What is claimed is:

1. A device for extracting dissolved oxygen from a liquid, comprising:
a hollow fiber membrane having a generally cylindrical outer wall, the hollow fiber membrane having a first end, a second end, and an internal lumen, wherein the hollow fiber membrane allows dissolved oxygen to pass through the outer wall and into the lumen;
an input fitting coupled to the first end of the hollow fiber membrane;
an output fitting coupled to the second end of the hollow fiber membrane; and
a passageway for directing the liquid across the surface of the hollow fiber membrane and thereby allowing oxygen to be extracted into the lumen of the hollow fiber membrane.

2. The device of claim 1, wherein the hollow fiber membrane prevents liquid from entering the lumen.

3. The device of claim 1, wherein the hollow fiber membrane has an outer diameter of between 100 and 400 microns.

4. The device of claim 1, wherein the hollow fiber membrane has an outer wall thickness of between 25 and 75 microns.

5. The device of claim 1, wherein the output fitting and the input fitting are coupled to a closed loop breathing system.

6. The device of claim 5, wherein the closed loop breathing system comprises distribution tubing.

7. The device of claim 6, further comprising a regulator incorporated into the distribution tubing.

8. The device of claim 6, further comprising a gas pump incorporated into the distribution tubing.

9. The device of claim 1 further comprising a fluid pump to move the liquid across the surface of the hollow fiber membrane.

10. The device of claim 5 wherein the closed loop breathing system is pressurized.

11. A gas exchange device, comprising:
a housing having an internal chamber, the housing having an inlet port and an outlet port for circulating a liquid containing dissolved oxygen throughout the internal chamber, the housing further comprising a gas inlet and a gas outlet;
a plurality of hollow fiber membranes each having a first end, a second end, and an internal lumen extending from the first end to the second end, wherein each of the first ends are coupled to the gas inlet and each of the second ends are coupled to the gas outlet;
wherein the plurality of hollow fiber membranes extract the dissolved oxygen within the liquid into the lumens when the liquid passes across the plurality of hollow fiber membranes.

12. The gas exchange device of claim 11, further comprising a gas distribution loop, the distribution having a first end in fluid communication with the gas inlet and a second end in fluid communication with the gas outlet.

13. The gas exchange device of claim 12, further comprising a regulator incorporated into the gas distribution loop.

14. The gas exchange device of claim 12, further comprising a gas pump incorporated into the gas distribution loop.

15. The gas exchange device of claim 12, further comprising an oxygen sensor incorporated into the gas distribution loop.

16. The gas exchange device of claim 12, further comprising a carbon dioxide sensor incorporated into the gas distribution loop.

17. A device for extracting dissolved oxygen from a liquid, comprising a gas exchange module, the gas exchange module comprising a plurality of hollow fiber membranes having a generally cylindrical outer wall, the plurality of hollow fiber membranes having a first end, a second end, and an internal lumen extending from the first end to the second end, wherein the plurality of hollow fiber membranes are adapted to allow dissolved oxygen to pass through the outer wall and into the lumen.

18. A method of extracting dissolved oxygen from a liquid, comprising:
providing a plurality of hollow fiber membranes having an internal lumen, and an outer wall with a pore size adapted to allow dissolved oxygen contained in the liquid to pass through the outer wall;
passing the liquid across the plurality of hollow fiber membranes; and
extracting a portion of the dissolved oxygen from the liquid.

19. The method of claim 18, further comprising retaining the portion of the dissolved oxygen within the hollow fiber membrane.

20. The method of claim 18, further comprising moving the extracted dissolved oxygen through the hollow fiber membranes.

21. The method of claim 18, further comprising passing carbon dioxide from within the lumens of the plurality of hollow fiber membranes through the outer wall.

22. An underwater breathing device, comprising:
water circulation means for circulating water within a housing;
means for extracting dissolved oxygen from the circulating water; and
means for distributing the extracted oxygen to a user.
